(19) United States
(12) Patent Application Publication
(10) Pub. No.: US 2026/0135314 A1
(43) Pub. Date: May 14, 2026

(54) SUBTERRANEAN WELL POWER CABLE CONNECTORS, SPLICING APPARATUS AND SPLICING METHODS

(71) Applicant: AL Cable Solutions LLP, Tulsa, OK (US)

(72) Inventors: Sean Anthony CAIN, Tulsa, OK (US); Lawrence Hugh BURLEIGH, Tulsa, OK (US)

(21) Appl. No.: 19/384,656

(22) Filed: Nov. 10, 2025

(30) Foreign Application Priority Data
Nov. 13, 2024 (GB) 2416698.5

(51) Int. Cl. H01R 13/02; H01R 11/07; H01R 13/52; H01R 13/631; H01R 43/033; H02G 1/00; H02G 1/14; H02G 9/06

(52) U.S. Cl. CPC H01R 13/025; H01R 11/07; H01R 13/5208; H01R 13/631; H01R 43/033; H02G 1/005; H02G 1/14; H02G 9/06

(57) ABSTRACT

This invention includes a system for splicing and insulating power cables and includes power cable connectors, an automated splicing tape wrapping method, and associated apparatus. The connectors address safety and quality concerns by requiring minimal specials tools nor special training to be installed. The automated tape wrapping method and apparatus is controlled by a computer or PLC (programmable logic controller) to enhance precision, safety, and efficiency. The method and apparatus allow for customizable wrapping parameters and speeds, making it adaptable for different materials and configurations of cable and tapes to be applied.

### CROSS-REFERENCE TO RELATED APPLICATION

The present application claims priority to Great Britain Patent Application No. 2416698.5 filed on 13 Nov. 2024, the disclosure of which is incorporated by reference herein in its entirety.

### BACKGROUND OF THE INVENTION

The oil and gas industry often utilizes an electrical submersible pumping (ESP) system to produce oil and gas from subterranean wells that have been drilled and completed for the purpose. The system utilizes a pump which could be centrifugal, progressive cavity, or a positive displacement type. The pump is powered via an electric motor which may be rotational or linear as required by the pump. There may be other mechanical and electrical devices in the system to aid in the efficient production of the well fluid. The electric permanent magnet or induction motors are normally powered via a power cable that extends from the surface to the motor and is usually suspended on the tubing supporting the ESP system or within the casing liner of the well completion. At the surface, the cable attaches to a wellhead penetrator or may extend through the well head to the power supply which may include a transformer, various pieces of control equipment and switchgear. On the downhole end, the cable may be spliced to a motor lead connection, to additional cable to provide added length, or to replace a damaged area of cable. The splice usually consists of an electrical butt splice connector to join the conductors together electrically and mechanically which is covered by multiple layers of insulation, barrier material, and protective metallic armor. This connector usually is mechanically attached using special crimping tools or soldered in place using a butt splice configuration. The butt splice connector installation entails a few challenges that stand in need of being addressed.
1. The installation requires special tools to apply the mechanical forces required to join the connector to the wire.
2. Proper selection and use of the tools is required to ensure mechanical integrity of the conductor portion of the splice.
3. The manual nature of the process results in variable crimp integrity.
4. The process of installing the connector can expose the installer to electrical hazards if the wiring is energized for whatever reason including external rotation of a permanent magnet motor in the circuit that creates voltage at the motor leads.

The interface between the tubular connector and cable conductor can overheat and fail if the contact area is insufficient, as well as reduce the mechanical holding of the splice connection. A convex tube or convex laminated tube placed between the tubular connector inner diameter and the conductor outer diameter increases and enhances the contact area to reduce localized heating.

Another means of improving the electrical contact to the connector and reducing the risk of overheating is by implementing a spiral spring that is circumferentially wrapped around the inner diameter of the connector such that the spring outer diameter convolutions contact the connector inner diameter and has dimensions that ensures the spring inner diameter convolutions make contact with the conductor and thus enhances the contact area to reduce localized heating caused by resistance to the electrical current.

Once the splice connector is completed, the electrical insulation must be installed. The insulation usually consists of wraps of tapes intended to both electrically insulate the splice joint and mechanically prevent ingress of liquids and gases from the well that could compromise the electrical integrity of the splice. The splice tapes are usually applied by hand by wrapping the tape in an overlapping manner and traversing the splice back and forth until the required electrical and mechanical integrity is achieved. The splice insulation may then be further mechanically reinforced by wrapping layers of lead (metallic) sheath and metallic armor to provide additional mechanical, corrosive, and gas ingress protection. These tape splices usually consist of many layers and many wraps that are applied manually. The manual application of the tapes entails a number of challenges that stand in need of being addressed.

The process can be challenging ergonomically and can result in injury to the personnel due to repetitive stress and other human physiological issues caused during the application process.
1. The process requires considerable time and the associated cost of personnel doing the work
2. Some of the splices occur at the well site, therefore the ambient weather can have an impact upon the splice quality
3. The process is very dependent on the skill of the personnel doing the process and thus can have variability in the quality level of the splice. A splice failure can have serious added consequences which add cost, time, and expose personnel to added hazards of working to correct the failure.
4. The process of installing the insulation can expose the installer to electrical hazards if the wiring is energized for whatever reason including external rotation of a permanent magnet motor in the circuit.

### OBJECT OF THE INVENTION

There is a need for devices, methods, and apparatuses to safely, efficiently, and consistently perform a power cable splicing function in a controlled shop environment and at the wellsite suitable for the splice to operate in a subterranean well environment. Specifically, a cable connector device and tape splicing wrapping method and apparatus which minimizes the need for special tooling and human intervention while reducing exposure to the ergonomic and electrical hazards that are posed with conventional cable splicing in a shop environment as well as at a wellsite. The connector does not require special tooling to install and the wrapping machine can be programmed via a computer or PLC to apply the proper tensions and wraps to create the splice and control the wrapping parameters to ensure integrity of the splice insulation with minimal manual intervention and effort.

Subterranean well power cable for electrical submersible pumps (ESPs) typically comprises three copper conductors with multiple layers of wrapped polyimide tape. An extruded layer of non-metallic material provides further protection and electrical insulation. Commonly, a layer of lead protects the copper conductor from hydrogen sulfide corrosion and protects the insulation from gas ingress and chemical degradation. A braided cover may be used to boost hoop strength and reinforce the insulation. High modules tape is applied compressing layers to minimize gas ingress. Finally, a layer of wrapped metallic armor encases all three conductors to provide mechanical protection. The tri-conductor configuration can be flat with all three conductors in the same plane or round with all three conductors in a triangular orientation. Optional additional conductors, ground wires, control wires, and instrument wires may also be incorporated in the cable configuration.

Currently, subterranean well cable connectors rely upon a manual tool to crimp the cable connector tube to contact the power cable conductor. After the tubular connector slides over the conductor, the crimp tool creates an indention in the connector's outer surface which pushes the inner surface to deform making contact mechanically and electrically with the conductor and providing mechanical retention of the connector to the wire. The crimping tool performs a scissor like action with the operators contact point being leveraged to the contact point of the conductor. Alternatively, a crimp tool can be operated pneumatically to provide enhanced compressive force. The consistency of the crimp can vary with the operators'energy level, the operators training, deformation pressure quality, air pressure variation, and the tool contact point being worn. Also affecting the consistency of the crimp is the requirement to use proper tooling which are compatible with the wire and connector to be crimped.

Layers of polyimide film, other insulation materials, high modulus tape, lead, and metallic armor must be added to provide electrical and mechanical integrity. The polyimide and high modulus tape must be applied by hand with great tension on the tape to assure a tight fit with the base conductor material. First in a clockwise direction for the first layer, then in a counterclockwise direction for the second layer for each conductor. The insulation materials are manually wrapped next, followed by the lead being wrapped. Each material to be wrapped requires differing tensions and wrapping techniques. Finally, the metallic armor is wrapped around all three conductors. The process involves several challenges: ergonomics, training, quality, and consistency.

Concave tubes may be used in electrical connections to assure connectivity and contact which reduces heat and arcing potential. The middle of the tube has a reduced inner diameter, whereas the ends have a larger outer diameter. The concave tube may be laminated, slotted, or otherwise configured to promote maximal electrical contact between the wire and the connector. The concave tube transfers the electrical current from the conductor which contacts the inner diameter of the concave tube to the outer connector which contacts the outer diameter of the concave tube. A spring-like, energized interference fit between the conductor outer diameter and the concave tube inner diameter creates a mechanical resistance to relative movement. Alternatively, the concave tube may have a longitudinal slit. The slit is compressed when the concave tube enters the conductor inner diameter creating a mechanical resistance to relative movement.

A ferrule compression connection is a type of fitting that uses a ferrule to grip the conductor and create a mechanical joint with a compression nut. A ferrule compression connection is made up of a nut, body, and a ferrule, which can be one piece or two pieces on each end of the connector. When the nut is tightened, it compresses the ferrule against the conductor, causing the ferrule to deform slightly and grip the conductor. This creates a mechanical joint that can withstand high axial loads and temperatures and an electrical connector to ensure good contact with the conductor. Ferrules come in different shapes and sizes, but they all have a tapered nose that grips the conductor.

There is a need for devices, methods, and apparatus to safely and efficiently perform cable splices suitable for a subterranean well environment.

According to the present invention, there are provided systems according to the independent claims.

### BRIEF DESCRIPTION

In order to address the limitations of existing technology for splicing downhole ESP cables, the invention eliminates the special tooling required for connecting the conductors and reduces and/or removes the handwork required to make a splice. The electrical conductor splice is joined via a connector using rotational motion via multiple means, either in conjunction or separately.

The invention includes three variations in the splicing connector design:
1. A self tapping design that includes a rotational operation that removes and reshapes the conductor to allow helical grooves (similar to threads) to be formed. The groove depths and shapes are enough to provide mechanical strength and electrical conductivity to the joint to allow sufficient strength in the direction axial to the conductor and connector.
2. A clamping and compression design that includes a rotational operation that forces a helical device (such as a specially shaped spring) to apply compressive force between the connector and the conductor to provide mechanical strength to the joint to allow sufficient mechanical strength in the direction axial to the conductor and connector and to provide sufficient electrical conductivity for delivering power through the cable.
3. A connector fitting consisting of a body and nuts on each end that can be configured to compress a gripping device such as a ferule or collet to grip the conductor mechanically and provide the necessary contact area to conduct the electricity.

For the first two designs, the connector can allow joining both conductors (one on each end of the connector) simultaneously by allowing one end of the helical device to have left-handed screw threads and the opposing end to have right-handed screw threads. The exterior of the connector can be configured to allow installation of the connector by hand or by rotating the connector with standard tooling such as a box wrench or spanner wrench while it helically engages the conductors.

For all 3 designs, the exterior of the connector can be provided with an insulator to prevent inadvertent exposure to any electrical voltages that may be present and thus prevent potential injuries to the installing personnel.

The connector with insulator can be configured with various sealing devices such as O-rings or gaskets to hermetically seal the joint and prevent moisture and contamination from entering the electrically insulated joint.

The connector can be fitted with other components such as a multi-laminated concave tube and/or electrical contact spring to improve the electrical contact with the wire or wires which will reduce the contact resistance and improve the ampacity of the connector.

The application of the electrical insulation portion of the invention incorporates a tape wrapping device that can be utilized on a cable that already has the conductors joined together with the need to feed one end of the cable which could be thousands of feet long axially through the tape wrapping machine. The tape wrapping device can be automated by using a computer or PLC to control the tape tension, speed, overlap, and wrapping pattern plus additional parameters deemed key to the user. The machine can be programmed to wrap the splice with different materials (both non-metallic and metallic), providing improved efficiency and consistency in splicing operations with minimal human intervention. The tape wrapping machine is designed and programmed to traverse the length of the splice without moving the cable to apply the splicing materials where required. This will typically require mounting the wrapping machine on a linear motion device such as a linear motor that moves the wrapping machine along the axial length of the cable. The linear motion device is mounted to a frame that also enables proper positioning and affixing of the cable pieces to allow the wrapping machine to wrap the cable splice. There may be other cable clamping, rollers, positioning, and holding devices that move with the wrapping machine to ensure the activity of wrapping does not inadvertently misalign the cable during the wrapping process.

### BRIEF DESCRIPTION OF DRAWINGS

Exemplary embodiments of the invention will now be described with reference to the drawings, of which:

FIG. 1 is a well section view of a well bore production configuration with a typical ESP system;

FIG. 2 is a diagram illustrating a typical three-phase power cable for subterranean duty;

FIG. 3 is a diagram of a typical splice connector and spliced three-phase power cable;

FIG. 4 are diagrams of a dual threaded and sealed cable connector;

FIG. 5 are diagrams of concave tubes which enhance the electrical connection;

FIG. 6 is a diagram of a connector with concave tube and sealing element;

FIG. 7A are diagrams of dual threaded cable connectors with hand tool interface options;

FIG. 7B are diagrams of dual threaded cable connectors manual hand interface options;

FIG. 8A are diagrams of dual threaded cable connectors with helical inserts;

FIG. 8B are diagrams of dual threaded cable connectors with alternative helical inserts;

FIG. 8C are diagrams of a cable connector utilizing a garter spring;

FIG. 8D are diagrams of a contractile mesh grip cable connector;

FIG. 8E are diagrams of a contractile mesh grip cable connector with adapters;

FIG. 8F are diagrams of a contractile mesh grip cable connector with compression spring;

FIG. 9A is a diagram of a ferrule compression type cable connector;

FIG. 9B are multi-view diagrams of the components in a ferrule compression type cable connector;

FIG. 9C is a diagram of an alternative ferrule compression type cable connector;

FIG. 9D are multi-view diagrams of the components in an alternative ferrule compression type cable connector;

FIG. 9E is a diagram of an alternative ferrule compression type cable connector;

FIG. 9F are multi-view diagrams of the components in an alternative ferrule compression type cable connector;

FIG. 10A is a diagram of dual threaded connectors attached to a three-phase power cable;

FIG. 10B is a diagram of dual threaded connectors attached to a three-phase power cable with layers of insulation;

FIG. 11A is an isometric diagram of a cable insulation wrapping apparatus;

FIG. 11B are multi-view diagrams of a cable insulation wrapping apparatus;

FIG. 11C is an isometric diagram of a cable insulation wrapping apparatus using a hydraulic actuator;

FIG. 11D is an isometric diagram of a cable insulation wrapping apparatus using an electric actuator;

FIG. 12A is an isometric diagram of a cable insulation wrapping apparatus internals;

FIG. 12B are multi-view diagrams of a cable insulation wrapping apparatus internals;

FIG. 13 is a diagram of a control panel;

FIG. 14 shows a flowchart of the wrapping process method.

### DETAILED DESCRIPTION

One or more embodiments of the invention are described below. It should be noted that these and any other embodiments described below are exemplary and are intended to be illustrative of the invention rather than limiting.

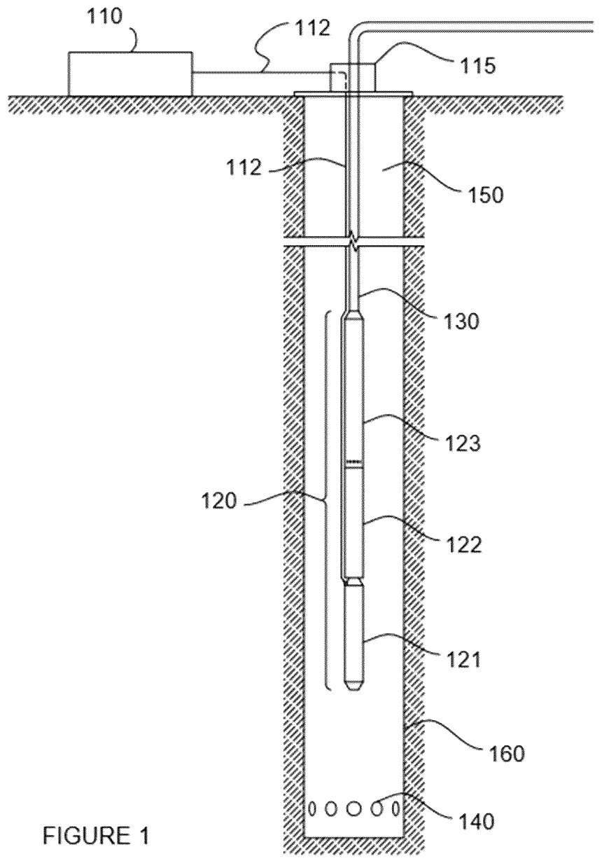

Referring to FIG. 1, there is shown a typical ESP system in a subterranean well. Downhole ESP system 120 consists of electric motor 121, seal section 122, and multistage centrifugal pump 123 installed within well casing 160 and above well perforations 140. Power cable 112 conveys power provided from variable speed drive 110 to motor 121 after passing through wellhead 115. Motor 121 rotates seal section 122 and multistage centrifugal pump 123. The pump 123 pushes the fluid up production tubing 130. Alternatively, the power cable alongside ESP system 120 possesses a smaller cross-sectional area and is referred to as a motor lead extension which requires a splice to attach to main power cable 112. Common power cable 112 splice locations are between a wellhead penetrator and the power cable 112, the power cable 112 to the motor lead extension, and in locations along the length of the power cable 112.

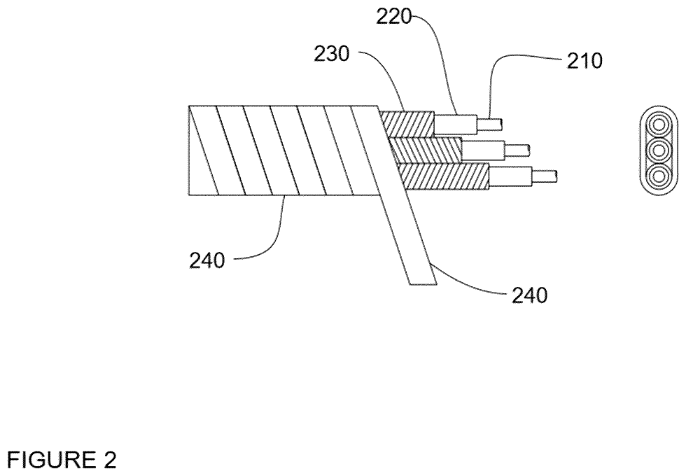

Referring to FIG. 2, there is shown a typical three phase power cable suitable for operation in a subterranean oil well environment. Metallic wrapped armor 240 protects three insulated conductors 210. Layer 220 provides electrical insulation. A layer of lead 230 may protect the conductor from hydrogen sulfide gas caused corrosion. A further alternative involves various materials which vary in purpose and quality.

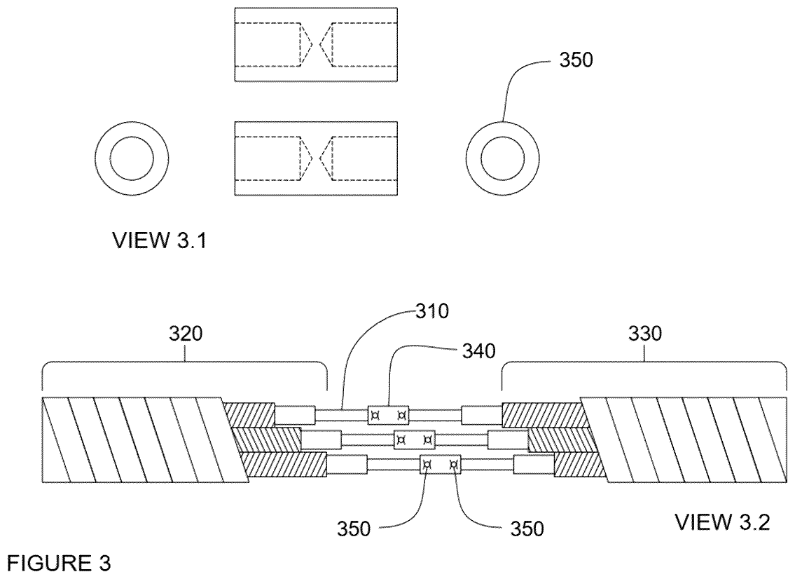

Referring to FIG. 3, there is shown a multi-view of a cable connector 340 and a diagram of a spliced three phase power cable. View 3.1 depicts front, top, left and right perspectives of a cable connector which will accommodate a crimped mechanical holding method. Holes on both ends accept two cable conductors to be mechanically attached. View 3.2 depicts a three phase power cable with spliced connectors. Three phase power cable section 320 attaches to three phase power cable section 330 with connectors 340. Crimp 350 mechanically restrains conductor 310 from exiting connector 340.

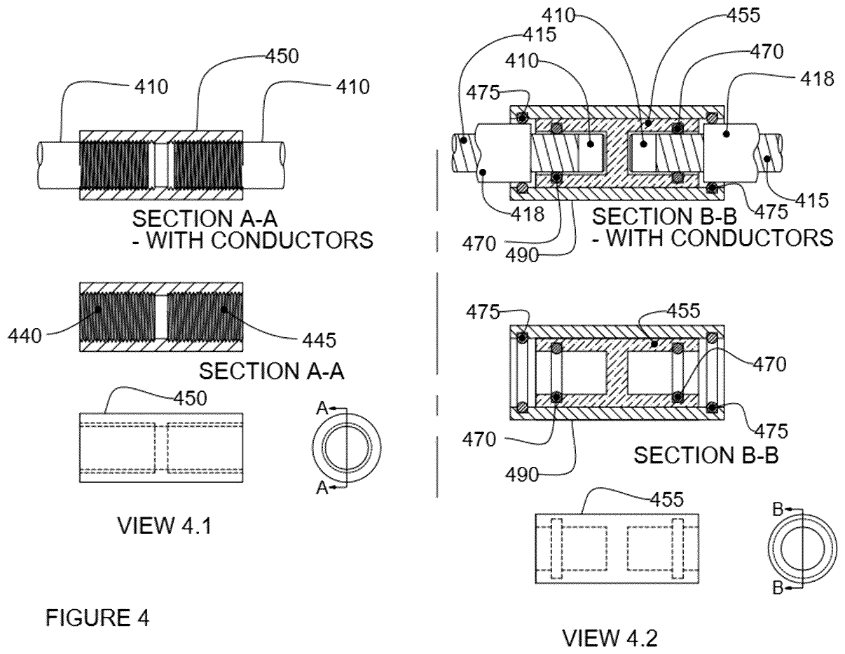

Referring to FIG. 4, there are shown multi-views of cable connector fitting with threaded internal holes and with a sealing element. View 4.1 depicts front and right perspectives, as well as sectioned views of a cable connector fitting 450 with internal threaded holes. The cable insulation is not shown for clarity. End holes accept cable conductors 410 to be connected. Section A-A demonstrates internal thread 440 on the left and thread 445 on the right. The helix of thread 440 draws conductor 410 into connector 450 when connector 450 rotates in a clockwise direction as viewed from one end. While continuing to view from the same end, the helix of thread 445 draws conductor 410 into connector 450 when connector 450 rotates in a counterclockwise direction. The rotation of connector fitting 450 draws in both conductors 410 concurrently. View 4.2 depicts front and right perspectives, as well as sectioned views of a cable connector fitting 455 with internal sealing elements. End holes accept cable conductors 410 to be connected. Sealing elements 470 and 475 prevent fluids and gas from contacting connection 455 internals. Section B-B shows a sectioned view of connector 455, outer insulation layer 490, and sealing elements 470 and 475. Conductors 410 inserted into connector fitting 455 with outer insulation layer 490. The power cable conductor shows an exposed area 410, a layer with wrapped insulation 415, and a layer with insulation 418. Sealing element 470 contacts the internal surface of connector 455 and the outer surface of insulated conductor 410. Sealing element 475 contacts the inner surface of insulation layer 490 and the outer surface of cable insulation layer 418. Alternatively, sealing element 470 may be omitted. A further alternative involves conductors of differing size or construction.

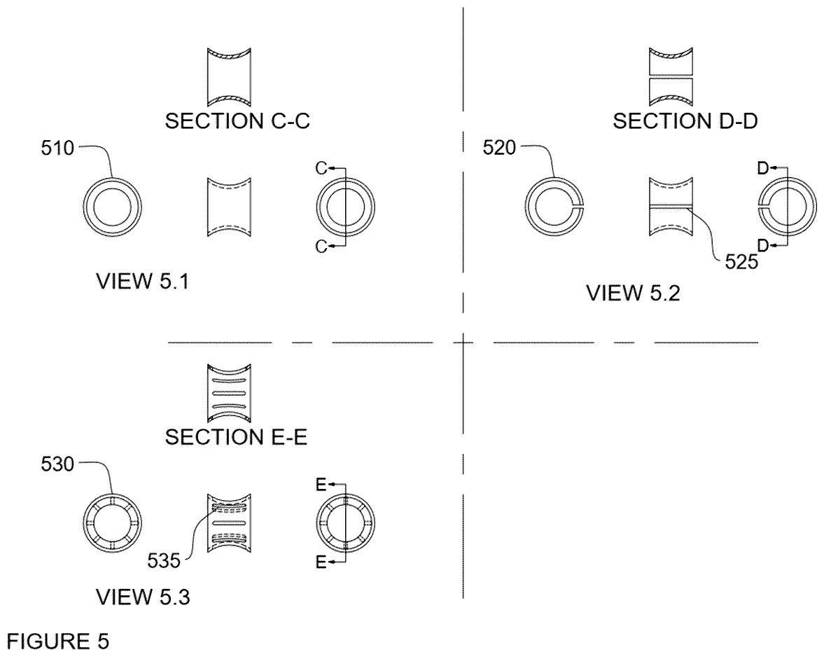

Referring to FIG. 5, there are shown multi-views of a concave tube which enhances connection connectivity, increases contact, and reduces arcing potential. View 5.1 depicts a front, left, right and sectioned view of concave tube 510. The outer diameter increases at the ends and decreases in the middle. View 5.2 depicts a front, left, right and sectioned view of a concave tube 520 with a longitudinal slit. The outer and inner diameters increase at the ends and decrease in the middle. An interference fit on the outer surface of concave tube 520 results in slit 525 providing a uniform radial force. View 5.3 depicts a front, left, right and sectioned view of a concave tube 530 with closed slits 535 which allow expansion of the inner surface to accept the cable conductor with good contact area.

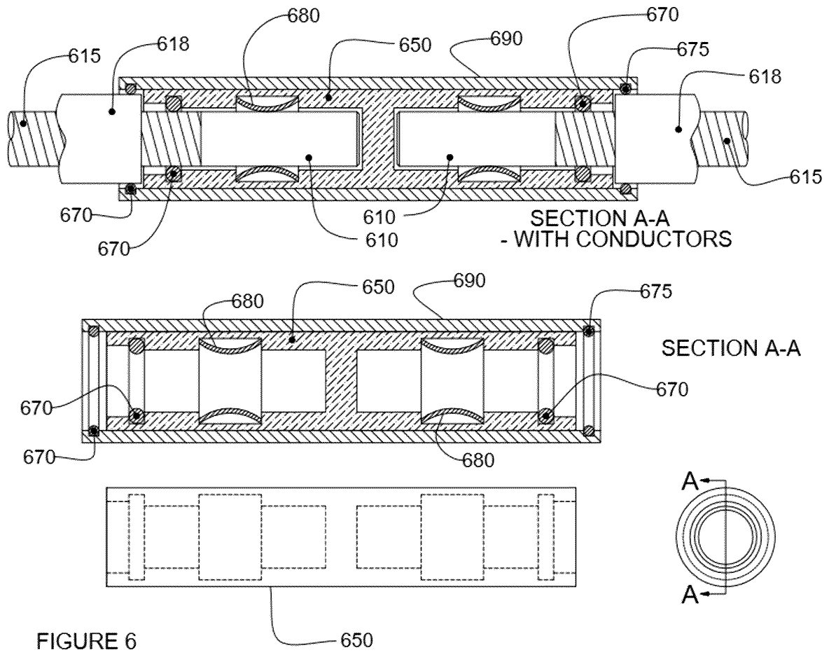

Referring to FIG. 6, there are shown multi-views of a cable connector with concave tubes and sealing elements. Cable connector 650 contains bores which accept concave tube 680 and sealing element 670. Section A-A shows a section view of connector 650, outer insulation layer 690, and sealing elements 670 and 675. A view labeled Section A-A with conductors shows the insertion of cable conductors with exposed section 610, multi-layered insulation layer 615, and insulation layer 618. Concave tube 680 contacts the inner surface of connector 650 and the outer surface of conductor 610 creating an interference which retains conductor 610 and creates good contact area for electrical current transference. Sealing element 670 contacts the inner surface of connector 650 and the outer surface of insulated conductor layer 615. Sealing element 675 contacts the inner surface of connector insulation layer 690 and the outer surface of connector insulation layer 618. Alternatively, conductors of differing sizes or construction are accommodated.

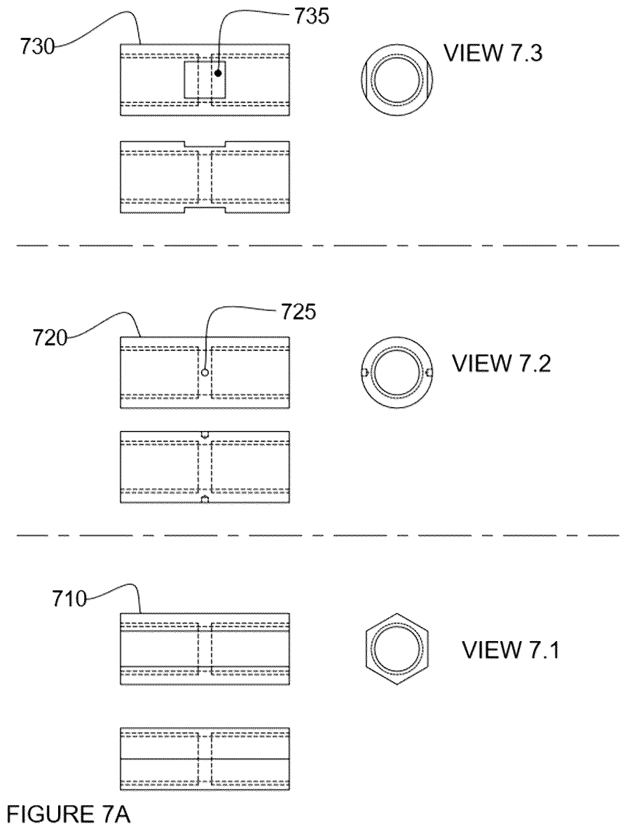

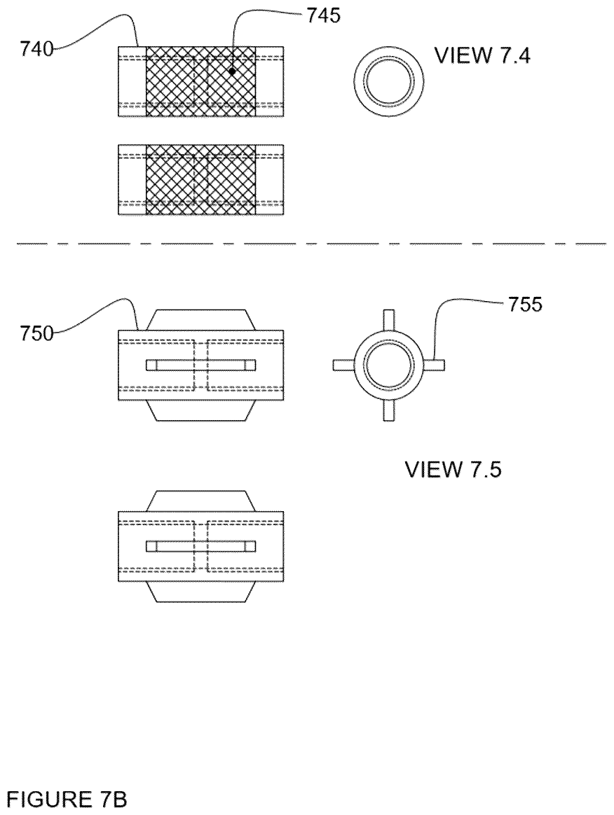

Referring to FIG. 7A, there are shown multi-views of cable connectors with differing external surfaces for applying torque to the connector. View 7.1 depicts top, front and side views of connector 710 with a hexagonal cross section such that torque can be transferred with a box wrench. View 7.2 depicts top, front and side views of connector 720 with radial holes 725 such that torque is transferred with a spanner wrench. View 7.3 depicts front and side views of connector 730 with opposite flat surfaces 735 such that torque can be transferred with a box wrench. Alternatively, conductors of differing sizes or construction are accommodated.

Referring to FIG. 7B, there are shown multi-views of cable connectors with differing external surfaces for applying torque to the connector. View 7.4 depicts top, front, and side views of connector 740 with knurled external surface 745 to enhance hand torquing. View 7.5 depicts top, front, and side views of connector 750 with fins 755 to enhance hand torquing. Alternatively, conductors of differing sizes or construction are accommodated.

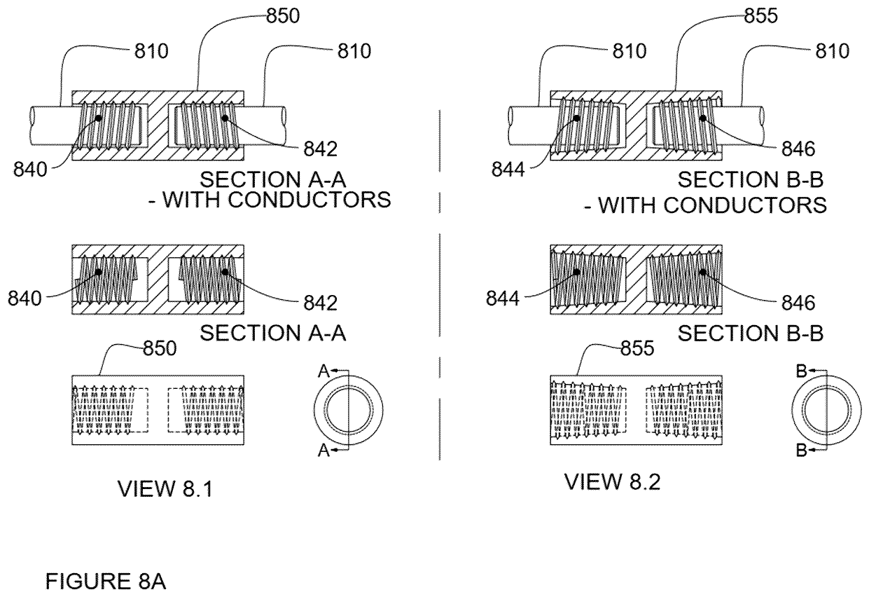

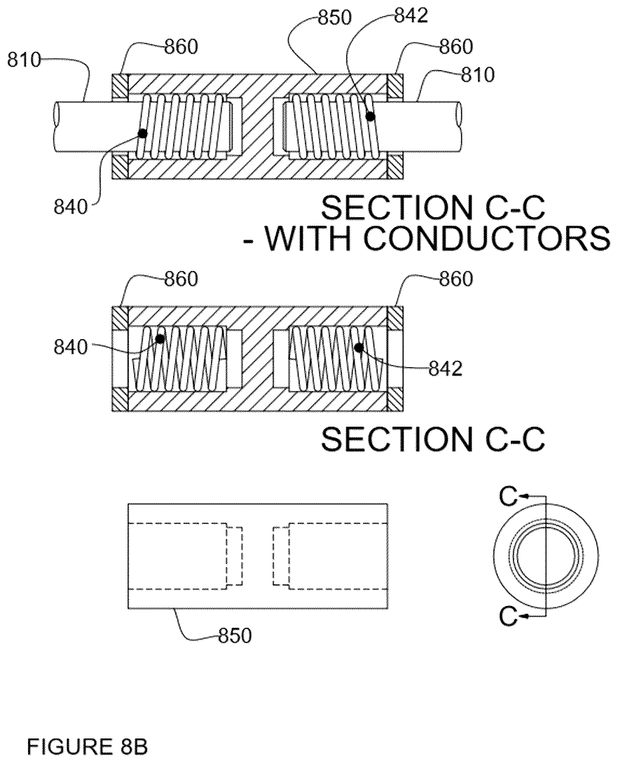

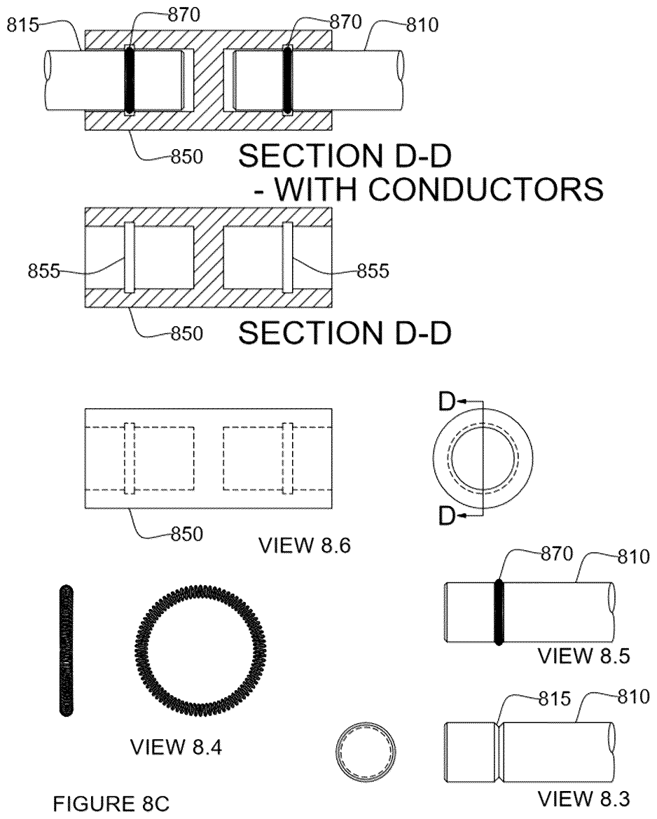

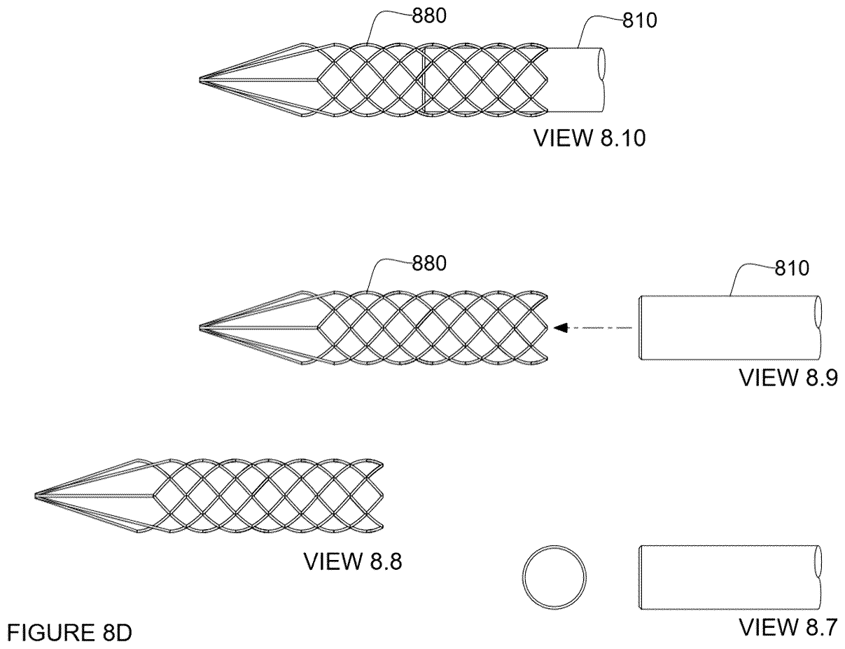

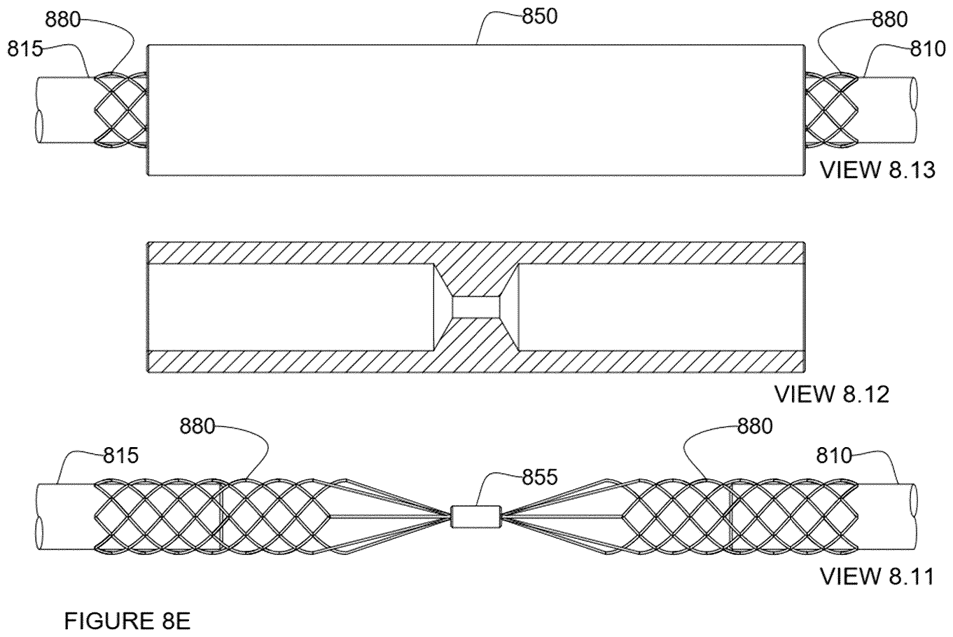

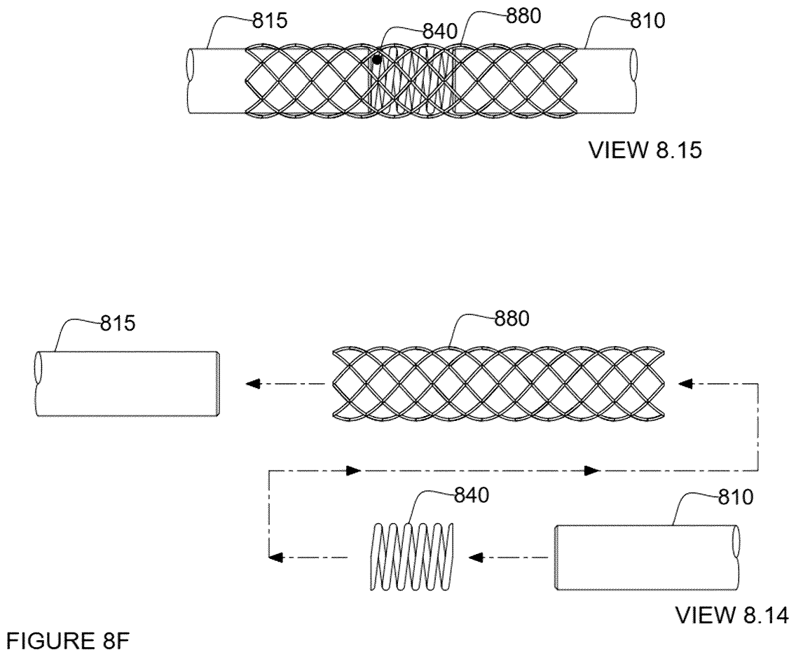

Referring to FIG. 8A, there are shown multi-views of cable connectors with a coil thread element. View 8.1 depicts tubular connector 850 with internal threads on both ends. The threads dimensions will accept a coil thread element. Section A-A shows clockwise coil thread element 840 on the left side threaded bore, and counterclockwise thread element 842 on the right-side threaded bore. View “Section A-A with Conductors” depicts conductors 810 threaded into coil thread elements 840 and 842. View 8.2 depicts tubular connector 855 with internal tapered threads on both ends. The threads dimensions with accept a tapered coil thread element. Section B-B shows clockwise tapered coil thread element 844 on the left side threaded bore, and counterclockwise tapered thread coil element 846 on the right side. View “Section B-B with Conductors” depicts conductors 810 threaded into coil thread elements 844 and 846. Alternatively, conductors of differing sizes or construction are accommodated.

Referring to FIG. 8B, there are shown multiple views of cable connectors with coiled conductors. Cable connector 850 contains bores which accept coiled conductors 840 and 842 which contact the inner surface of connector 850 wrapping around the outer surface of conductor 810 occupying the volume between the inner surface of connector 850 and the outer surface of conductor 810. Cap 860 retains coiled conductors 840 and 842. Alternatively, conductors of differing sizes or construction are accommodated.

Referring to FIG. 8C, there are shown multiple views of cable connectors with garter springs. View 8.3 shows single solid cable conductor 810 with circumferential v-groove 815. View 8.4 shows a garter spring. View 8.5 shows garter spring 870 installed in the circumferential v-groove of cable conductor 810. View 8.6 shows adapter 850. Section D-D shows the bore and inner relief diameters 855 within adapter 850. View “Section D-D with conductors” shows conductor 810 and garter spring 870 engaged in the bore and inner relief diameter of adapter 850, as well as conductor 815 and garter spring 870 engaged on the opposite end of adapter 850. When conductor 810 and garter spring 870 are inserted into adapter 850, garter spring 870 enters v-groove 815 by pivoting its coils which reduces the outer diameter of garter spring 870. Upon encountering inner relief diameter 855 garter spring 870 raises out of v-groove 815 increasing the outer diameter of garter spring 870. Alternatively, a multitude of garter springs are utilized on each conductor. A further alternative involves adapter 850 engaging one conductor 810 and garter spring 870.

Referring to FIG. 8D, there are shown multiple views of a cable conductor connector with contractile mesh grip. View 8.7 shows a cable conductor constructed of solid material. View 8.8 shows a contractile mesh grip which allows a cylindrical object to be inserted, however upon removal of the cylindrical object the woven mesh restricts the removal. View 8.9 shows conductor 810 being inserted into contractile mesh grip 880. View 8.10 shows conductor 810 inserted within contractile mesh grip 880. Alternatively, the construction of conductor 810 is stranded rather than solid.

Referring to FIG. 8E, there are shown multiple views of a cable connector using a contractile mesh grip. View 8.11 shows solids cable conductor 810 inserted into contractile mesh grip 880 and conductor 815 inserted into the opposite end of mesh 880. Adapter 855 increases the removal resistance of conductors 810 and 815 by reducing the outer diameter of contractile mesh 880. View 8.12 shows an adapter with an inner diameter restriction. View 8.13 shows cable conductor 810 engaged within contractile mesh grip 880 and adapter 850 and cable conductor 815 engaged within contractile mesh grip 880 and adapter 850 on the opposite end of adapter 850. Alternatively, two contractile mesh grips 880 are joined with adapter 855 or adapter 850. With a further alternative, the construction of conductors 810 and 815 are stranded rather than solid. With yet a further alternative, cable conductor 810 and 815 are of dissimilar construction or size.

Referring to FIG. 8F, there are shown multiple views of a cable connector using a contractile mesh grip. View 8.14 shows solid cable conductor 810 and compression spring 840 being inserted into one end of contractile mesh grip 880 and solid cable conductor 815 being inserted into the opposite end of contractile mesh grip 880. View 8.15 shows solid cable conductor 810, compression spring 840, and conductor 815 inserted within contractile mesh grip 880. The compressive force from conductors 810 and 815 results in contractile mesh grip 880 resisting conductors 810 and 815 from exiting contractile mesh grip 880. Alternatively, the construction of conductors 810 and 815 are stranded rather than solid. With a further alternative, cable conductors 810 and 815 are of dissimilar construction or size.

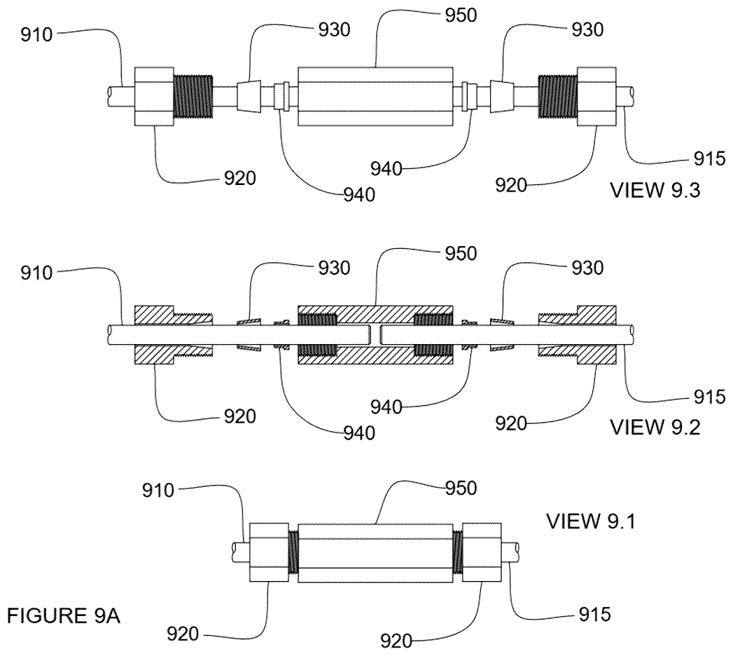

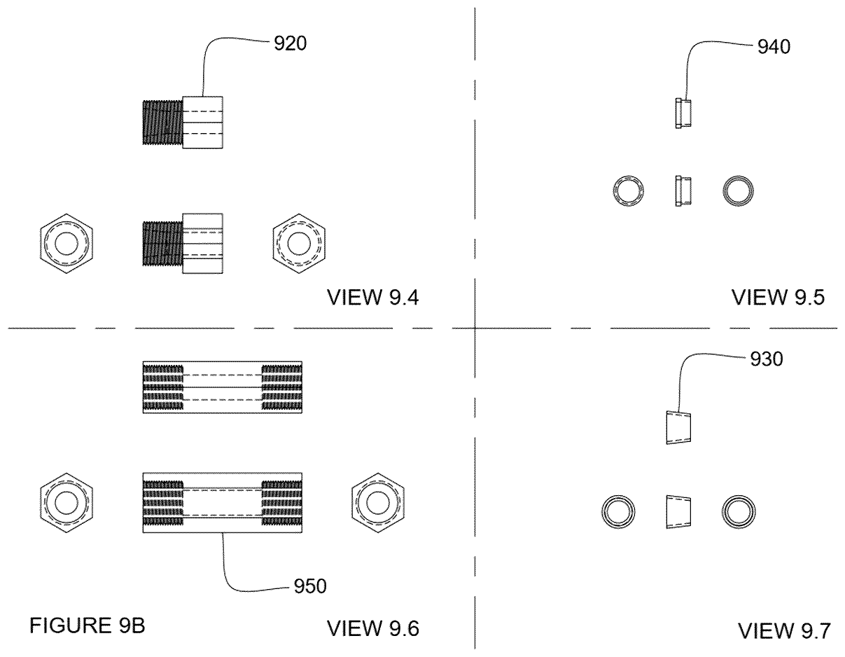

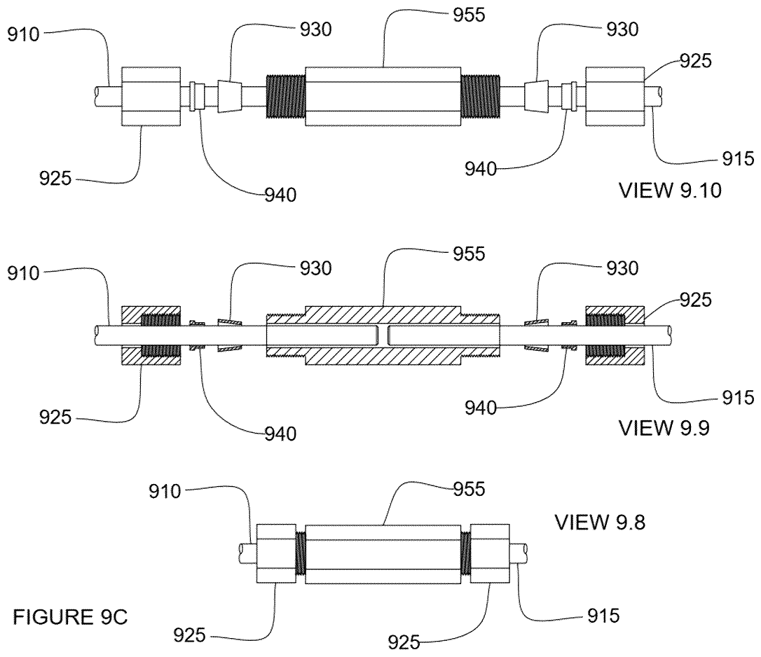

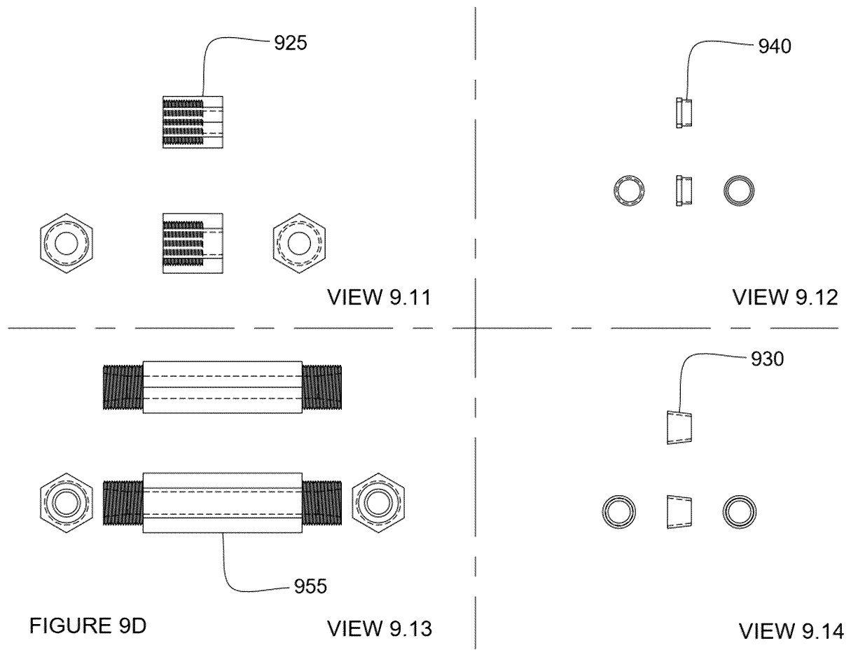

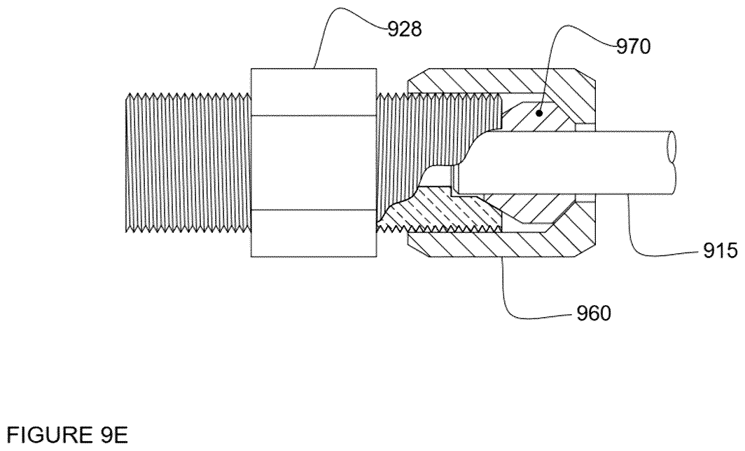

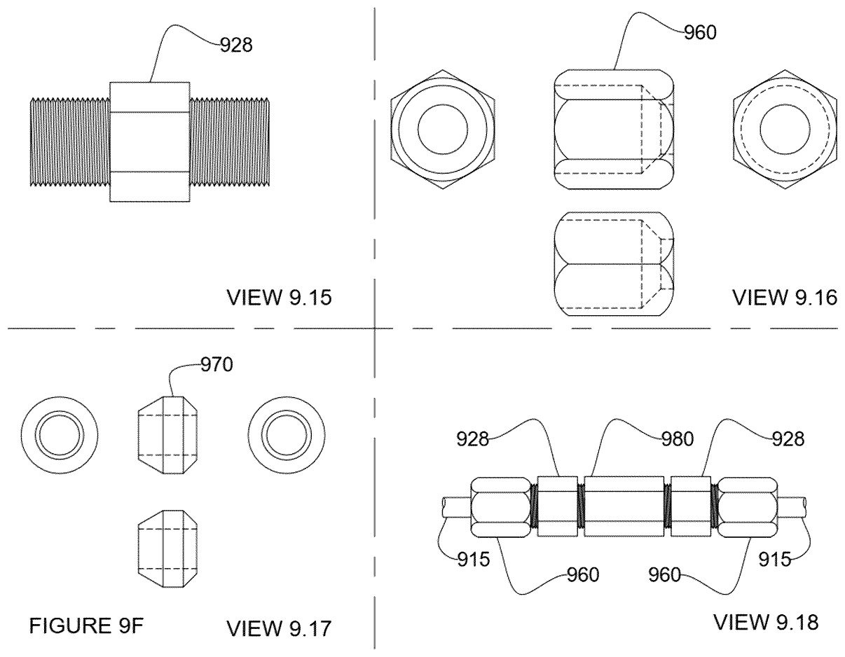

Referring to FIG. 9A, there are shown views of a tubular cable conductor connector using ferrule compression to mechanically retain the conductors. View 9.1 shows unassembled conductors 910 and 915 retained in tubular connector 950 and with compression nut 920 fully engaged. View 9.2 shows a sectional exploded view of the ferrule compression arrangement before assembly. Conductors 910 and 915 pass through compression nut 920, front ferrule 930, and back ferrule 940 before entering tubular connector 950. View 9.3 depicts the assembled arrangement without cross sectioned components. Conductors 910 and 915 pass through compression nut 920, front ferrule 930, and back ferrule 940 before entering tubular connector 950. Alternatively, tubular connector 950 may have a non-tubular external surface. A further alternative integrates back ferrule 940 into connector 950. With a further alternative, conductors of differing sizes or construction are accommodated.

Referring to FIG. 9B, there are shown multi-view depictions of the compression nut, back ferrule, tubular connector, and front ferrule. View 9.4 shows front, left, right, and top views of compression nut 920. A thru bore accepts the cable conductor. Threads engage with tubular connector 950. The tapered bore engages with front ferrule 930. View 9.5 shows front, left, right, and top views of back ferrule 940. A thru bore accepts the cable conductor. The shoulder contacts counterbore of tubular connector 950. The smaller outer diameter engages with front ferrule 930. View 9.6 shows front, left, right and top views of tubular connector 950. To affix the conductors, torque is applied to the hexagonal exterior with a box wrench. The internal threads on both ends accept compression nut 920. The internal thru bore accepts the conductors. View 9.7 shows front, left, right, and top views of front ferrule 930. The tapered bore engages with back ferrule 940. The tapered exterior engages with compression nut 920. Alternatively, conductors of differing sizes or construction are accommodated.

Referring to FIG. 9C, there are shown views of a tubular cable conductor connector with ferrule compression to mechanically retain the conductors with the connector having external threads and the nut having internal threads. View 9.8 shows conductors 910 and 915 retained in tubular connector 955 and with compression nuts 925 fully engaged. View 9.9 shows a sectional exploded view of the ferrule compression arrangement before assembly. Conductors 910 and 915 pass through compression nut 925, front ferrule 930, and back ferrule 940 before entering tubular connector 955. View 9.10 depicts the pre-assembled arrangement without cross sectioned components. Conductors 910 and 915 pass through compression nut 925, front ferrule 930, and back ferrule 940 before entering tubular connector 955. To affix the conductors torque is applied to the hexagonal exterior surfaces of compression nut 925 and tubular connector 755 with a box wrench. Alternatively, tubular connector 955 may have a non-tubular external surface. A further alternative integrates back ferrule 940 into connector 950. Alternatively, conductors of differing sizes or construction are accommodated.

Referring to FIG. 9D, there are shown multi-view depictions of the compression nut, back ferrule, tubular connector, and front ferrule. View 9.11 shows front, left, right, and top views of compression nut 925 with internal threads. A thru bore accepts the cable conductor. Threads engage with tubular connector 955. View 9.12 shows front, left, right, and top views of back ferrule 940. A thru bore accepts the cable conductor. The shoulder contacts the counterbore of compression nut 925. The smaller outer diameter engages with front ferrule 930. View 9.13 shows front, left, right and top views of tubular connector 955 with external threads which connect to the internal threads of compression nut 920. The internal thru bore accepts the conductors. View 9.14 shows front, left, right, and top views of front ferrule 930. The tapered bore engages with back ferrule 940. The tapered exterior engages with compression nut 925.

Referring to FIG. 9E, there is shown an assembly view of conductor ferrule compression connector arrangement for a single cable conductor. Torque applied to the hexagonal surfaces of adapter 928 and compression nut 960 result in conductor 915 being retained by compressed ferrule 970.

Referring to FIG. 9F there are shown component multi-views and an assembled view of a single cable conductor ferrule compression connection. View 9.15 depicts adapter 928 with external threads which engage with compression nut 960. View 9.16 depicts compression nut 960 with internal threads which engage with adapter 928, a through bore which allows the cable conductor to enter, and an internal angled shoulder which interfaces with ferrule 970. View 9.17 depicts ferrule 970 with a through bore which allows the cable conductor to enter, one angled external surface which interfaces with compression nut 960, and another angle external surface which interfaces with adapter 928. View 9.18 depicts an assembled view of two single cable conductor ferrule connections with conductors 915 installed being joined with union adapter 980. Compression nuts 928 join union adapter 980 to compression nut 928. The internal threads on the opposite ends of union adapter 980 will have left-handed screw threads and right-handed screw threads, so that the two single conductor connections are pulled together simultaneously when torque is applied to union adapter 980. Alternatively, the threads on the ends of union adapter 980 match. A further alternative involves conductors of differing sizes or construction. With a yet further alternative union adapter 980 and one or both adapters 928 are integrated into one piece.

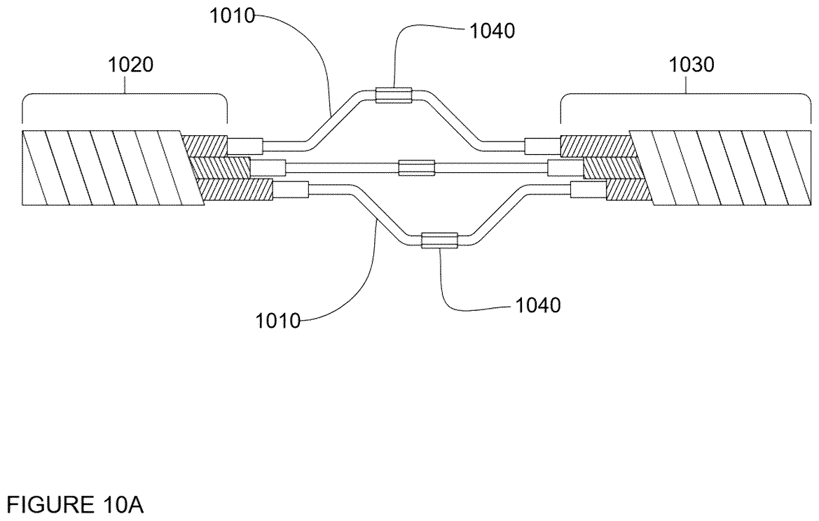

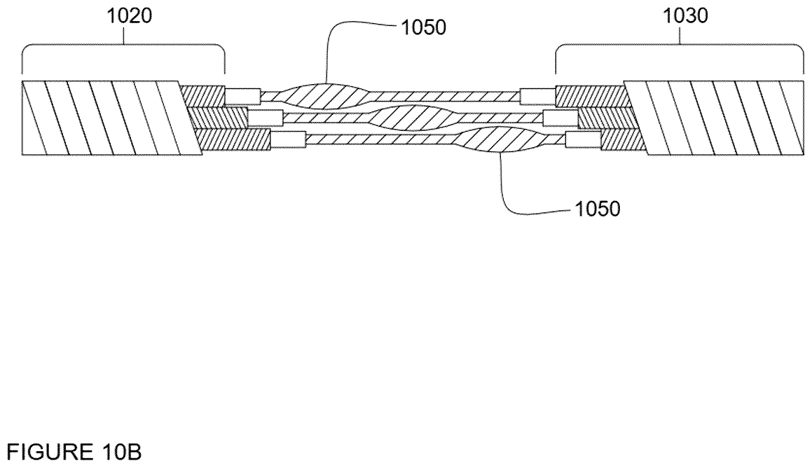

Referring to FIG. 10A, there is shown a three-phase power cable spliced with non-crimped connectors. Power cable 1020 is affixed to power cable 1030. Tubular connector 1040 joins conductors 1010.

Referring to FIG. 10B, there is shown a three-phase power cable spliced with insulation wrapping covering the splices and cable conductor. Power cable 1020 is affixed to power cable 1030. Insulation wrap 1050 covers the crimps and individual cable conductors.

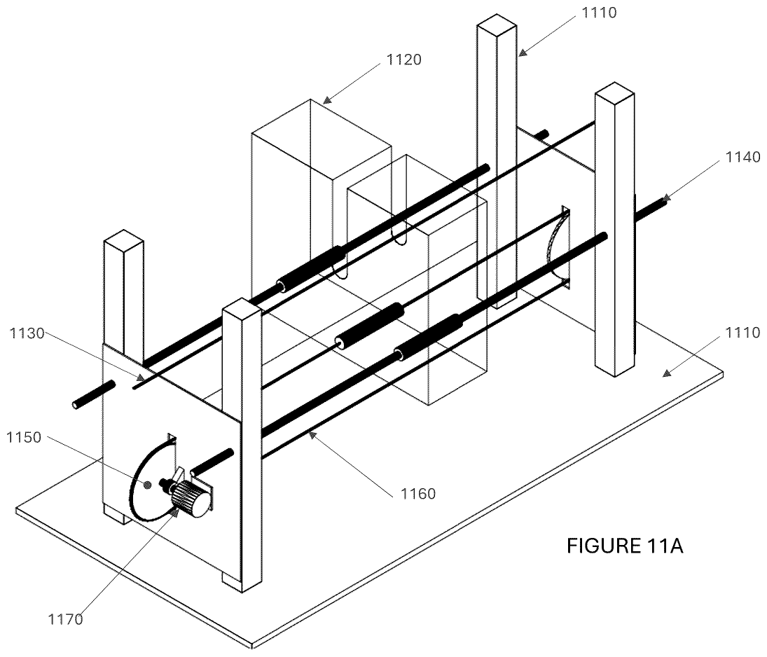

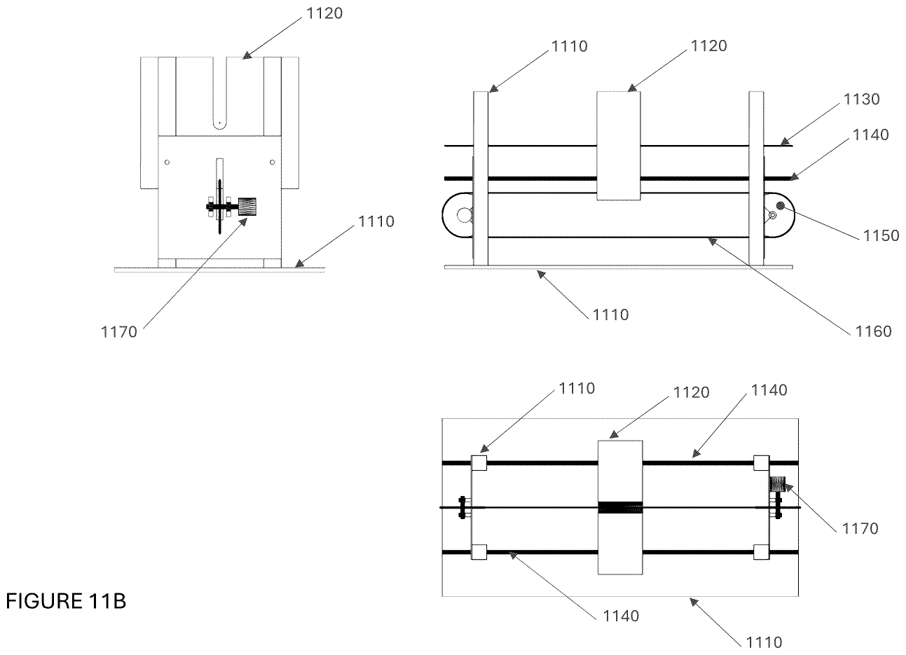

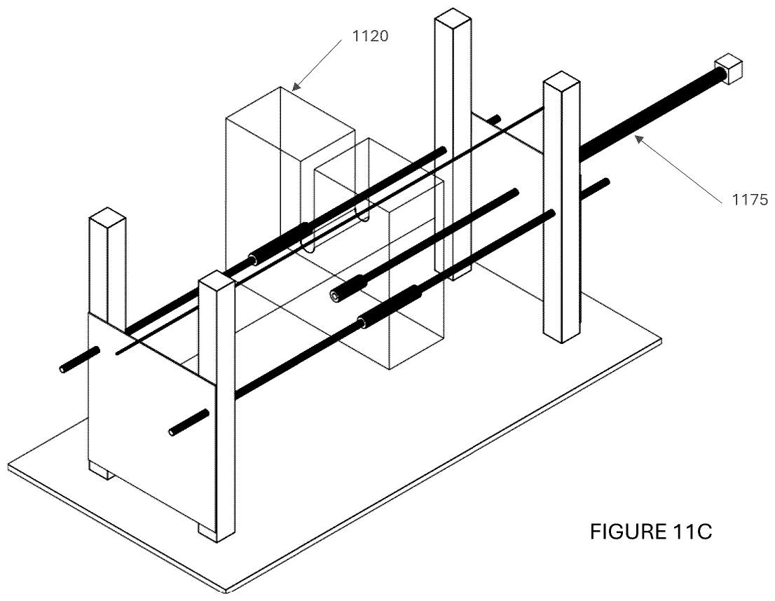

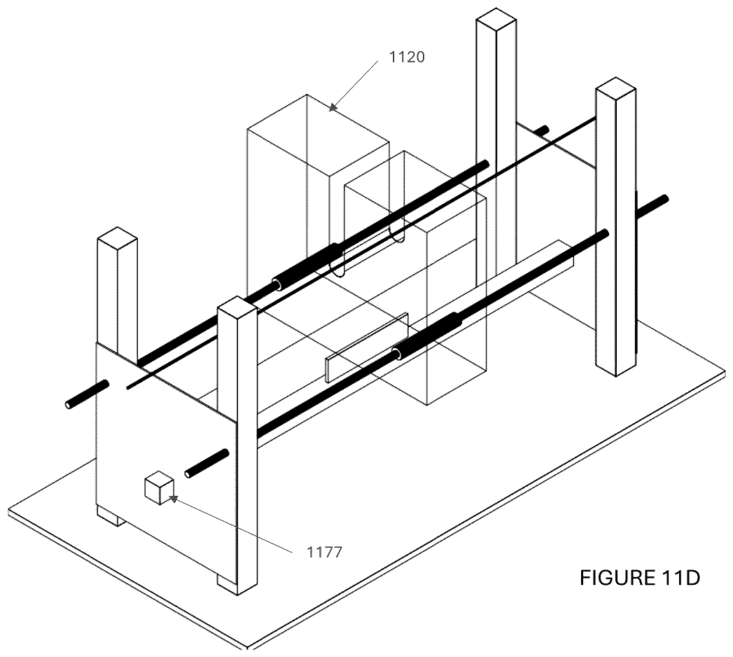

Referring to FIG. 11A, there is shown an isometric view of a tape wrapping apparatus. Frame 1110 consists of a floor plate, vertical support posts, and vertical mounting support plates. The tape wrapping apparatus resides within box 1120 which tracks on guides 1140. Motor 1170, drive wheel 1150, and cord 1160 energize box 1120 to track. Power cable 1130 enters box 1120 for the wrapping operation. Box 1120 tracks while power cable 1130 remains stationary with rollers, clamps, or other holding mechanism. Alternatively, motor 1170 may energize box 1120 with a chain and sprocket arrangement.

Referring to FIG. 11B, there are shown multi-views of a tape wrapping apparatus. Motor 1170 mounts to frame 1110 and energizes box 1120 to track with drive wheel 1150. Cord 1160 transfers the rotational energy from drive wheel 1150 to box 1120 as linear energy. Guides 1140 maintain a linear tracking motion of box 1120. Cable conductor 1130 enters box 1120 for the wrapping operation.

Referring to FIG. 11C, there is shown an isometric view of a tape wrapping machine apparatus driven by a hydraulic actuator. Hydraulic linear actuator 1175 energizes box 1120 to track rather than a motor and drive wheel arrangement.

Referring to FIG. 11D, there is shown an isometric view of a tape wrapping machine apparatus driven by an electric actuator. Electric linear actuator 1177 energizes box 1120 to track rather than a motor and drive wheel arrangement.

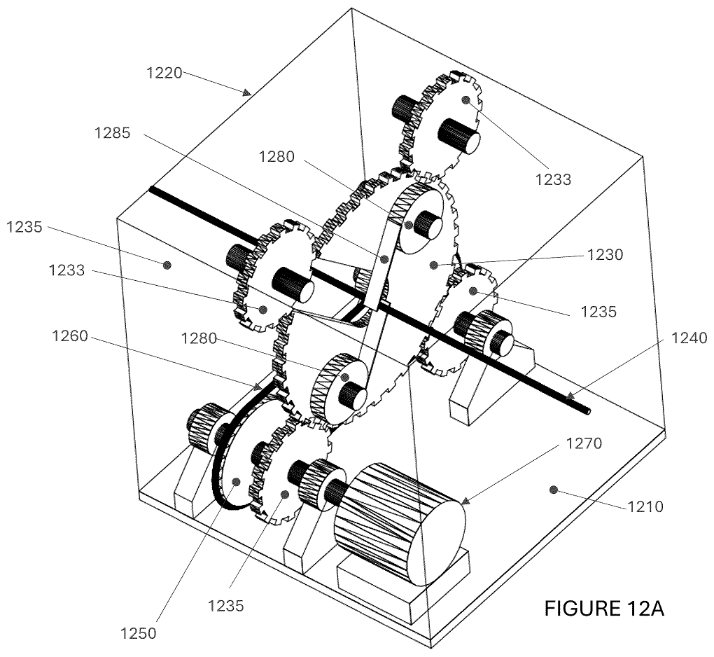

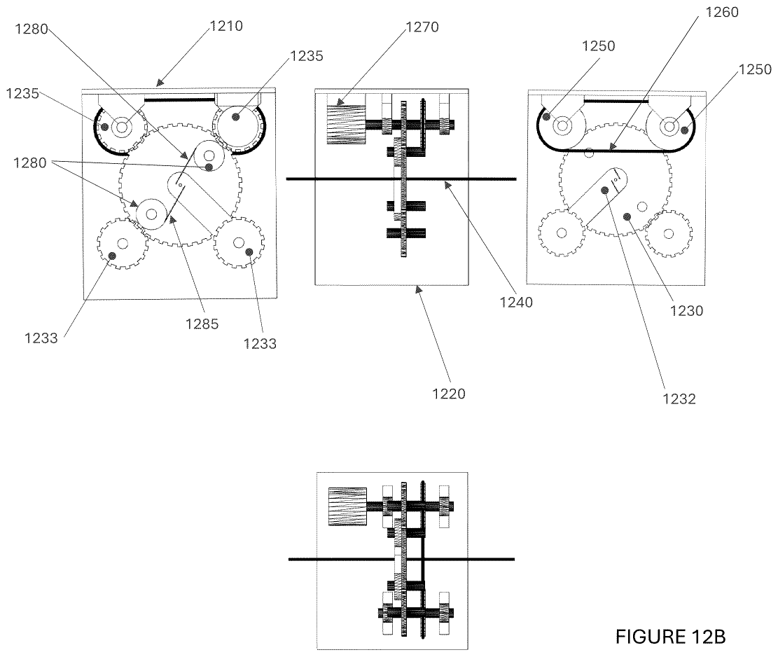

Referring to FIG. 12A, there is shown an isometric view of a tape wrapping apparatus. Motor 1270 mounts to base 1210 and drives gear 1235 and drive wheel 1250. Belt 1260 energizes complementary gear 1235. Gears 1235 energize main gear 1230 to rotate. Two gears 1233 guide main gear 1230 to rotate and oppose driver gears 1235. Two tape dispensers 1280 mount to main gear 1230 and rotate with main gear 1230. Tape 1285 adheres to cable conductor 1240. The opposite mounting of tape dispensers 1280 results in stabilizing cable conductor 1240 and an opposing force of the tension of tape 1285. The device contained within box 1220 moves linearly as main gear 1230 and tape dispensers 1280 rotate around cable conductor 1240 to apply tape 1285 in multiple overlapping layers. Alternatively, tape dispensers 1280 are mounted on springs to provide tension. A further alternative involves a separate arm to provide tension of the tape 1285. A further alternative may have a multitude of tape dispensers or a multitude of planetary gears.

Referring to FIG. 12B, there are shown multi-views of a tape wrapping apparatus. Motor 1270 mounts to base 1210 and drives gears 1235 and drive wheel 1250. Cord 1260 energizes complementary drive wheel 1250 which energizes complimentary gear 1235. Gears 1235 energize main gear 1230 to rotate. Two gears 1233 guide main gear 1230 to rotate and oppose driver gears 1235. Two tape dispensers 1280 mount to main gear 1230 and rotate with main gear 1230. Tape 1285 adheres to cable conductor 1240. Slot 1232 in main gear 1230 allows cable conductor 1240 to be centered so that insulation tape 1285 can be applied. The device contained within box 1220 moves linearly as main gear 1230 and tape dispensers 1280 rotate around cable conductor 1240 to apply tape 1285 in multiple overlapping layers. Alternatively, there are a multitude of drive gears 1235 and gears 1233. A further alternative involves a multitude of tape dispensers 1280.

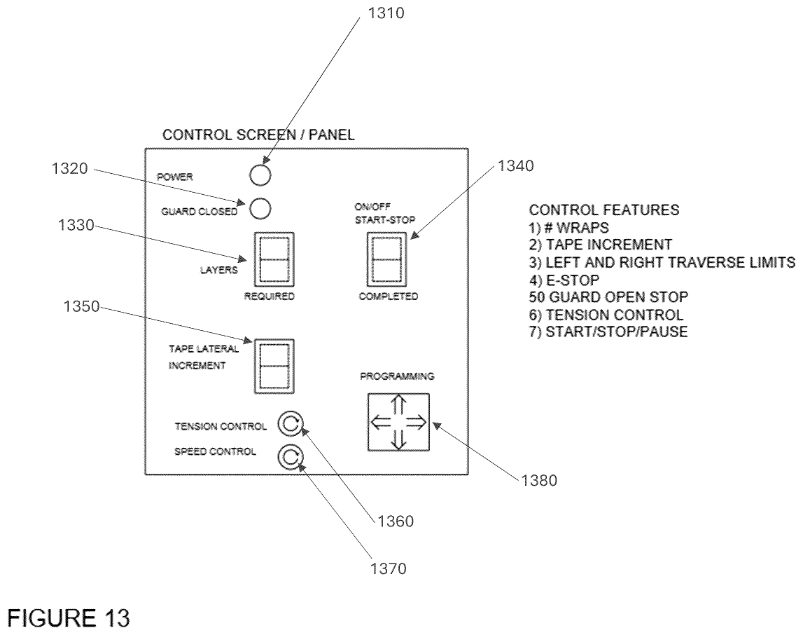

Referring to FIG. 13, there is shown a control screen for a tape dispensing process which may be presented from a monitor near the tape winding apparatus or presented on a hand-held electronic device or a personal mobile device. Power light 1310 indicates the energized status of the insulation tape dispending apparatus. Guard closed light 1320 indicates the position of a safety barrier. Layer counter 1330 reports the current tape layer number compared to the number of tape layers required. Status indicator 1340 the process has started, has stopped, or has been completed. Lateral increment indicator 1350 states the tape overlap. Tension control 1360 adjusts the tape tension. Speed control 1370 slows down or speeds up the tape application process.

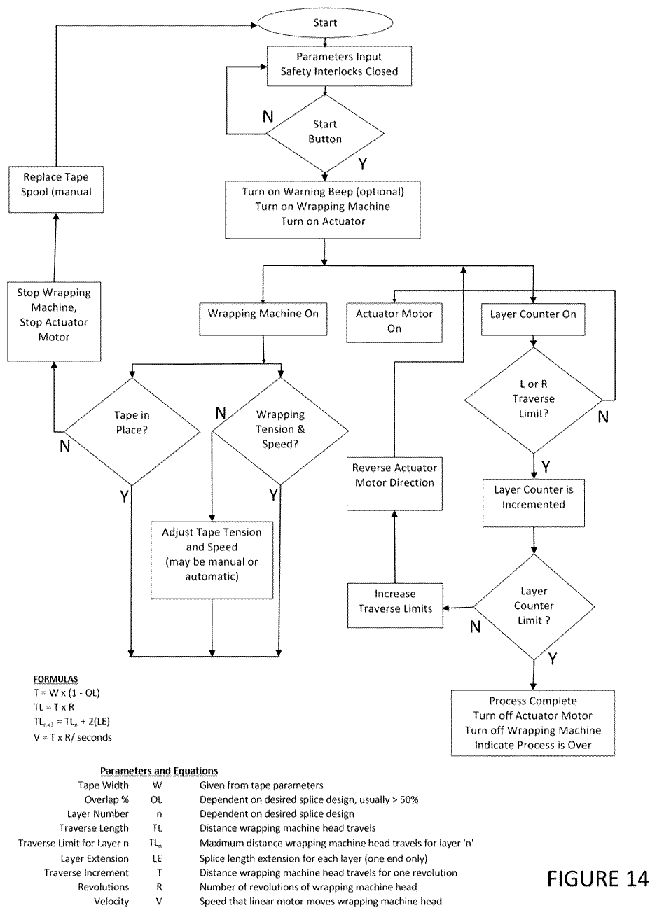

Referring to FIG. 14, there is shown a flowchart of the method to apply multilayered insulation tape to a cable conductor. At the top of the flowchart is the start bubble. First parameters are the input of parameters and the enactment of safety interlocks. The start button is pressed. If inputs are incorrect or safety barriers are not in place, then the focus moves back to the parameter inputs and safety interlock confirmation box. If the inputs are correct and the safety barriers are in place then an optional warning beep is sounded, and the wrapping machine, linear actuator, and layer counter are energized. After energizing the wrapping machine, sensors confirm the presence of the insulation tape and that the tape dispensing tension and speed are within required parameters. If the tape is not in place, then the apparatus is de-energized until the tape is replaced. If the tension or speed does not meet parameters, then adjustments are made manually or automatically. After energizing the layer counter, sensors track the traverse distance. If the traverse limit has not been reached, then the linear actuator will continue to move the winding apparatus. If the traverse distance limit has been reached, then confirmation of multi-layered wrapping execution is input. If further execution is required, then the actuator and winding apparatus are reversed. However, if the process has been executed properly, then the process is complete. Parameters and inputs are listed at the bottom of FIG. 14 comprising tape width, overlap percentage, layer number, traverse length, traverse limit for incremental layer ‘n’, layer extension, traverse increment, revolutions, and velocity. Formulas for traverse increment, traverse length, incremental traverse length, and velocity are stated.

We claim:

1. A cable connector for subterranean power cables, comprising:
a connector body having opposed conductor-receiving bores; and
an engagement structure disposed within each bore and configured to develop a mechanical interference fit between a conductor inserted into the bore and the connector body so as to mechanically secure the conductor and provide electrical contact between the conductor and the connector body.

2. The cable connector of claim 1, wherein the engagement structure comprises internal or external screw threads configured such that rotation of the connector body draws each conductor axially into the corresponding bore.

3. The cable connector of claim 1, further comprising at least one sealing element disposed between the connector body and an insulated portion of each conductor to inhibit ingress of fluid or gas into the connector.

4. The cable connector of claim 1, further comprising a concave or slotted contact tube positioned between the connector body and the conductor to enlarge an electrical contact area between them.

5. The cable connector of claim 1, wherein the engagement structure includes a spring element configured to exert a radial compressive force between the connector body and the conductor.

6. The cable connector of claim 1, further comprising a ferrule compressed between the connector body and an end member so as to grip the conductor mechanically and provide electrical continuity.

7. The cable connector of claim 6, wherein at least one of the ferrule or the connector body includes axial slits forming collet arms that contract radially upon tightening of the end member.

8. The cable connector of claim 1, wherein the engagement structure comprises a helical wire insert or coil positioned between the connector body and the conductor to produce the mechanical interference fit.

9. The cable connector of claim 1, wherein the connector is configured to join conductors of different diameters or constructions, including solid and stranded conductors.

10. An apparatus for applying insulation tape to a splice in a power cable, comprising:
a frame;
a guide structure supported by the frame and extending parallel to an axis of the power cable;
a wrapping head mounted to the guide structure and movable along the axis of the power cable;
at least one tape dispenser carried by the wrapping head and rotatable about the axis of the power cable to apply tape around the splice as the wrapping head moves along the guide structure; and
a tensioning arrangement configured to control the tension of tape as it is applied.

11. The apparatus of claim 10, wherein the wrapping head is driven in longitudinal motion by a motor-driven or actuator-driven translation system, the actuator being hydraulic, electric, or pneumatic.

12. The apparatus of claim 10, further comprising a programmable logic controller or electronic control system configured to regulate tape tension, rotation speed, and traverse rate, and to monitor completion of successive tape layers.

13. The apparatus of claim 10, wherein the wrapping head carries a plurality of tape dispensers arranged to rotate simultaneously about the power cable to apply overlapping layers of tape.

14. The apparatus of claim 10, further comprising clamps or rollers configured to restrain the power cable against lateral movement during wrapping.

15. The apparatus of claim 10, wherein the apparatus is adapted for use in horizontal, vertical, or angled orientations and sized for transport and operation in either a workshop or well-site environment.

16. The apparatus of claim 10, wherein the tape dispensers are configured to apply multiple layers of insulating, lead, or metallic-armor tape in a programmed sequence.

17. The apparatus of claim 10, further comprising sensors configured to detect tape presence, tension, or an energized cable condition and to halt operation upon detection of a fault.

18. A method of applying insulation tape to a splice in a power cable, comprising:
securing the power cable against movement relative to a frame;
rotating at least one tape dispenser about the power cable; and
traversing a wrapping head along the power cable while the tape dispenser rotates, thereby applying overlapping layers of tape around the splice.

19. The method of claim 18, further comprising inputting wrapping parameters including at least a tape width, overlap percentage, and number of layers, and initiating operation of the apparatus according to the input parameters.

20. The method of claim 18, further comprising monitoring at least one sensor signal indicative of tape presence, tension, or axial position and adjusting the rotational and/or traverse speed based on the monitored signal.

21. The method of claim 18, wherein the traverse direction is alternated between successive layers so that the overlap orientation reverses for each layer.

22. The method of claim 18, further comprising controlling operation of the apparatus by an algorithm that:
receives input parameters including at least a tape width, target overlap percentage, and number of layers;
computes from the input parameters an axial traverse increment per revolution and corresponding rotational and traverse speeds that produce the target overlap;
operates the apparatus according to the computed speeds while rotating at least one tape dispenser about the power cable and traversing the wrapping head axially;
monitors at least one sensor signal indicative of tape presence or axial position;
adjusts the rotational and/or traverse speed based on the monitored signal and reverses traversal between layer endpoints until the number of layers has been applied; and
halts operation upon detection of a fault condition.
